(19) United States
(12) Patent Application Publication
(10) Pub. No.: US 2010/0066906 A1
(43) Pub. Date: Mar. 18, 2010

(54) Transmission Method, Transmission System, Transmission Apparatus, and Reception Apparatus

(76) Inventor: Yasuhisa Nakajima, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/447,931

(22) PCT Filed: Oct. 29, 2007
(86) PCT No.: PCT/JP2007/071054

§ 371 Date: Apr. 30, 2009

(30) Foreign Application Priority Data
Oct. 30, 2006 (JP) 2006-294588

(51) Int. Cl. H04N 5/04

(52) U.S. Cl. 348/500; 348/E05.009; 348/723; 348/725

(57) ABSTRACT

The present invention is applied to data transmission using a transmission technique where video data of predetermined bit units is transmitted in pixel data units from a source side apparatus to a sink side apparatus in synchronization with a pixel clock. At least part of a transmission path between the source side apparatus and the sink side apparatus is converted to a wireless transmission path. The sink side apparatus stores information relating to one of a display capability and a reproduction capability for video of the sink side apparatus. In one of the source side apparatus and the sink side apparatus, one of a transmission speed and a transmission rate of video data on the wireless transmission path is determined, and when the source side apparatus reads out the information relating to the one of the display capability and the reproduction capability for video stored in the sink side apparatus, the stored information is modified by the source side apparatus in accordance with the one of the transmission speed and the transmission rate determined. By doing so, it is possible to suitably transmit video data on a wireless HDMI standard transmission path.

### TECHNICAL FIELD

The present invention relates to a transmission method and a transmission system that can be suitably applied to a digital video/audio input/output interface standard called HDMI (High-Definition Multimedia Interface) standard and to a transmission apparatus and a reception apparatus applied to such transmission system, and in particular to a technology where transmission is carried out on wireless transmission paths.

### BACKGROUND ART

In recent years, an interface standard called HDMI standard has been developed as an interface standard that allows uncompressed digital video data and the like to be transmitted between a plurality of video devices. HDMI standard is a standard that transmits video data separately in single pixel units as primary color data of respective colors. Audio data is also transmitted using transmission lines for video data during blanking intervals in the video data. The primary color data transmitted can be three channels of primary color data (R data, G data, and B data) for the additive primaries red, green, and blue, or can be Y, Cb, Cr luminance and color-difference signals.

According to HDMI standard, data of one pixel of each color is fundamentally constructed in units of eight bits. Sync signals such as horizontal sync signals and vertical sync signals are transmitted at timing where the respective sync signals are placed. In addition, with an HDMI standard interface, a separate channel is used to transmit control data and a pixel clock. The control data can be transmitted not only from a transmission side device (source side device) for video data to a reception side device (sink side device) but also from the reception side device (sink side device) to the transmission side device (source side device). In the source side device, the data is encrypted in eight-bit units and in the sink side device, data is decrypted from such encryption in eight-bit units.

According to HDMI standard, the sink side device includes a memory that stores E-EDID information, the information stored in such memory is transferred to the source side device, and the source side device determines the capability of the sink side device and determines the format and the like of video data to be transmitted by the source side device. The E-EDID information stored in the sink side device will be described in detail later in the embodiments, but in simple terms, when the device is a display apparatus, for example, the E-EDID information is data on the video display capability of displaying by such device (that is, formats that can be displayed). Such information is read out by the source side device and video data of an appropriate format is transmitted. The expression “format” given here is information on the number of pixels that construct a one-frame image, the frame rate, and the like, and differences in format lead to differences in transmission rate.

Japanese Unexamined Patent Application Publication No. 2006-33575 discloses an exchange of E-EDID information between a source side device and a sink side device according to HDMI standard.

However, when devices are connected by an HDMI standard cable, there has been the problem that the distance over which signals can be transmitted is limited by the length of the cable. Transmission on an HDMI standard cable is transmission at an extremely high clock rate, and when the length of the cable itself has increased, there is the problem of deterioration in transmission characteristics, which hinders transmissions.

To solve this problem, it would be conceivable to convert a transmission path to a wireless path, for example, but when wireless transmission is used, it becomes necessary to consider the transmission characteristics on the wireless transmission path, and there is the possibility that suitable transmission may not be carried out by merely using a setting of transmission format based on the read-out E-EDID information according to HDMI standard described above. For example, when the state of the wireless transmission path is unsuitable, there is the possibility that the sink side device may not be capable of properly receiving data even if the E-EDID information is read out and the data is transmitted using a format permitted by the E-EDID information.

The present invention was conceived in view of the points described above and aims to be able to suitably transmit video data on a wireless transmission path according to HDMI standard.

The present invention was conceived in view of the problems described above and aims to interpolate a high-frequency signal more suitably using a simplified construction.

### DISCLOSURE OF THE INVENTION

The present invention applied to data transmission using a transmission technique where video data of predetermined bit units is transmitted in pixel data units from a source side apparatus to a sink side apparatus in synchronization with a pixel clock. At least part of a transmission path between the source side apparatus and the sink side apparatus is converted to a wireless transmission path. The sink side apparatus stores information relating to one of a display capability and a reproduction capability for video of the sink side apparatus. In one of the source side apparatus and the sink side apparatus, one of a transmission speed and a transmission rate of video data on the wireless transmission path is determined, and when the source side apparatus read outs the information relating to the one of the display capability and the reproduction capability for video stored in the sink side apparatus, the source side apparatus modifies the information in accordance with the one of the transmission speed and the transmission rate determined.

Accordingly, information, which relates to one of the display capability and reproduction capability of the sink side apparatus and is stored in the sink side apparatus, is modified with consideration to a transmission state of the wireless transmission path and is then transmitted to the source side apparatus, and the transmission capability on the wireless transmission path is also shown by such information.

According to the present invention, when the source side apparatus transmits video data, the read information is used to determine the format and the like of the video data to be transmitted. Accordingly, transmission that considers any deterioration in the wireless transmission state of the wireless transmission path becomes possible, so that video data of an appropriate format can be transmitted and correctly transmitted to the sink side apparatus.

### BRIEF DESCRIPTION OF THE DRAWINGS

FIG. 1 is a block diagram showing one example of a system construction according to an embodiment of the present invention.

FIG. 2 is a schematic diagram showing one example structure of transmission channels according to the present embodiment.

FIG. 3 is a schematic diagram showing one example of a bit structure according to an embodiment of the present invention.

FIG. 4 is a schematic diagram showing one example of the data structure of E-EDID information.

FIG. 5 is a schematic diagram showing one example of video formats shown by the E-EDID information.

FIG. 6 is a schematic diagram showing one example of a data structure of a main portion of the E-EDID information.

FIG. 7 is a schematic diagram showing one example where the E-EDID information is modified according to an embodiment of the present invention.

FIG. 8 is a schematic diagram showing one example of a table showing correspondence between E-EDID information and transmission rates.

FIG. 9 is a flowchart showing an example of processing according to an embodiment of the present invention.

FIG. 10 is a block diagram showing one example of a system construction according to another embodiment of the present invention.

FIG. 11 is a block diagram showing one example of a system construction according to yet another embodiment of the present invention.

### BEST MODE FOR CARRYING OUT THE INVENTION

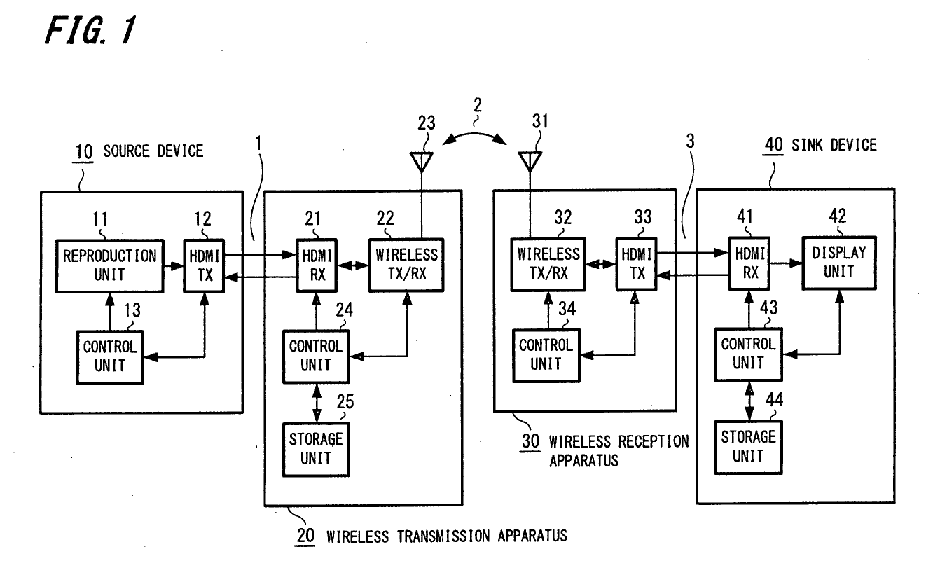

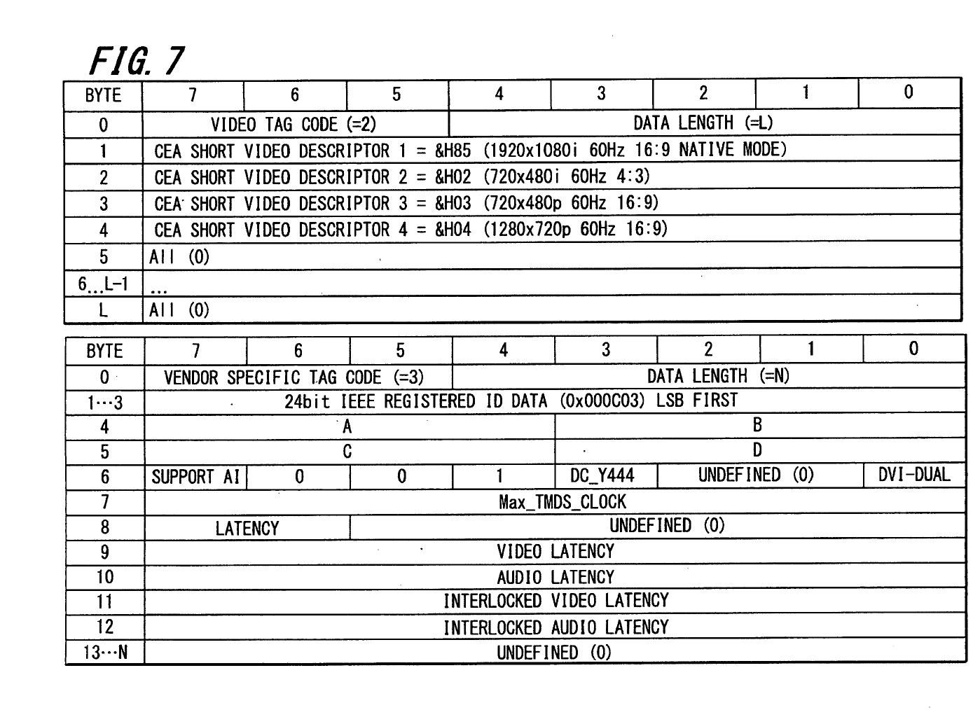

Preferred embodiments of the present invention will now be described with reference to FIGS. 1 to 9.

The present embodiment is applied to a transmission system in which video data and the like are transmitted from a source device to a sink device according to HDMI standard. FIG. 1 is a diagram showing an example system construction according to the present embodiment, where video data, audio data, and the like according to HDMI standard are transmitted from a video recording/reproducing apparatus as a source device 10 to a television set as a sink device 40. The source device 10 includes a video data output terminal according to HDMI standard. The sink device 40 includes a video data input terminal according to HDMI standard.

The source device 10 is connected to a wireless transmission apparatus 20 by an HDMI cable 1. The sink device 40 is connected to a wireless reception apparatus 30 by an HDMI cable 3. A wireless transmission path 2 is constructed by wireless transmission carried out between the wireless transmission apparatus 20 and the wireless reception apparatus 30. As a wireless transmission method used on the wireless transmission path 2, as one example, it is possible to use the wireless transmission standard IEEE 802.11n. IEEE 802.11n standard is a wireless transmission method that uses an MIMO (Multiple Input Multiple Output) arrangement, and is capable of wireless transmission at a comparatively high bitrate.

The constructions of the respective devices will now be described. The source device 10 includes a reproduction unit 11 that supplies video data, audio data, and the like of a video content played back from a medium to an HDMI transmission unit 12. When supplying such data to the HDMI transmission unit 12, settings such as the number of pixels in one frame of video and the frame rate can be changed according to control by a control unit 13. The control unit 13 also controls the reading of E-EDID information described later. The HDMI transmission unit 12 carries out processing of transmitting video data or the like from the HDMI terminal to the HDMI cable 1. The HDMI transmission unit 12 also receives some data, such as control data.

The wireless transmission apparatus 20 includes an HDMI reception unit 21 and carries out processing of receiving video data and the like transmitted via the HDMI cable 1. The wireless transmission apparatus 20 also transmits some data, such as control data. The data received by the HDMI reception unit 21 is subjected to wireless transmission processing by a wireless transmission/reception unit 22 and is wirelessly transmitted from a connected antenna 23. The wireless transmission/reception unit 22 is also capable of receiving data. Transmission processing by the wireless transmission apparatus 20 is carried out according to control by a control unit 24. A storage unit 25 is connected to the control unit 24 and stores E-EDID information required for communication with the source device 10 on an HDMI cable. However, E-EDID information stored in the storage unit 25 of the wireless transmission apparatus 20 is not information on the wireless transmission apparatus 20 itself but is information stored after modifying the E-EDID information read out from the sink device 40 in accordance with a wireless communication state of the wireless transmission path 2. The control for carrying out such modification is carried out by the control unit 24.

The wireless reception apparatus 30 includes a wireless transmission/reception unit 32 connected to an antenna 31, and data received by the wireless transmission/reception unit 32 is supplied to an HDMI transmission unit 33 and is transmitted from the HDMI transmission unit 33 via the HDMI cable 3 to the sink device 40. The HDMI transmission unit 33 is also capable of receiving control data and the like. The transmission processing by the wireless reception apparatus 30 is carried out according to control by a control unit 34.

The sink device 40 includes an HDMI reception unit 41 and supplies video data transmitted from the wireless reception apparatus 30 to a display unit 42 that displays video. The HDMI reception unit 41 can also transmit control data and the like. The HDMI reception unit 41 receives data and the display unit 42 displays data according to control by a control unit 43. A storage unit 44 is connected to the control unit 43. The storage unit 44 stores E-EDID information, which is information on types of video format that can be displayed by the sink device itself. Note that when the sink device 40 is a reproduction device capable of reproduction processing where the HDMI reception unit 41 is output from an output terminal of a different format, the capability of reproduction processing may be stored as the E-EDID information.

Although the constructions and the like required for HDMI standard will be described in order below, the existing HDMI standard is fundamentally used as is, and the construction of the HDMI cable 1 and the like are the same as those in the past. Audio data is multiplexed so as to be transmitted using blanking intervals of channels on which video data is being transmitted. Processing of placing and transmitting the audio data in the blanking intervals is typical transmission processing the format of which has been decided by HDMI standard.

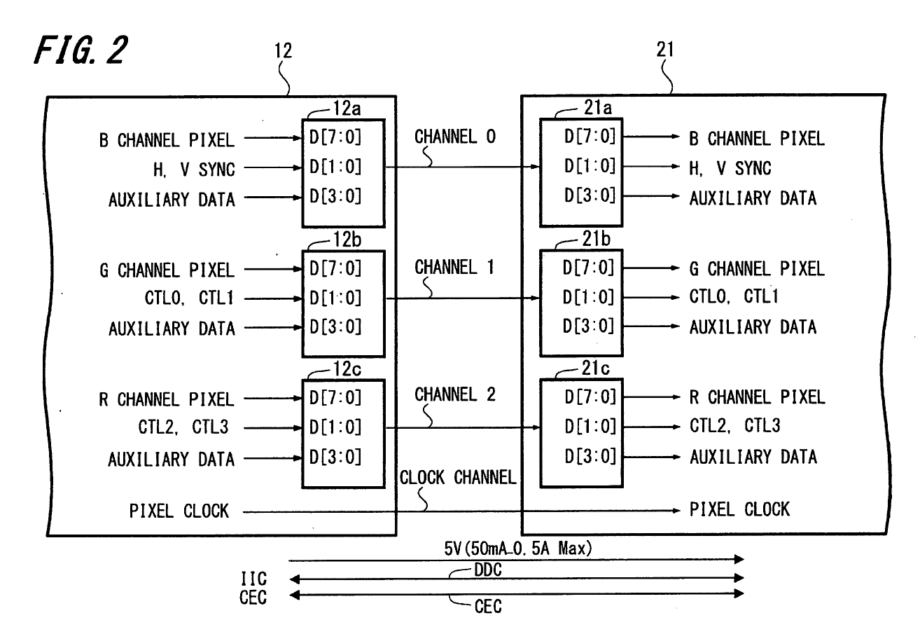

FIG. 2 is a diagram showing an example structure of data on each channel transmitted on the HDMI cable 1 between the HDMI transmission unit 12 of the source device 10 and the HDMI reception unit 21 of the wireless transmission apparatus 20. An example structure of data on each channel transmitted on the HDMI cable 3 between the wireless reception apparatus 30 and the sink device 40 is also the same.

As shown in FIG. 2, three channels, that is, channel 0, channel 1, and channel 2, are provided as the channels that transmit video data, and a clock channel for transmitting a pixel clock is also provided. A DDC (Display Data Channel) line and a CEC (Consumer Electronics Control) line are provided as control data transmission channels. The DDC line is a transmission path mainly used to transmit data that controls display and the CEC line is a transmission path mainly used to transmit one another device control data and the like between the connected devices.

On the transmission side, transmission processing units (transmission units) 12a, 12b, and 12c are provided in the HDMI transmission unit 12 for respective channels that transmit video data, and on the reception side also, transmission processing units (data reception units) 21a, 21b, and 21c are provided in the HDMI reception unit 21 for respective channels that transmit video data.

The construction of each channel is as follows. On channel 0, pixel data for B data, vertical sync data, horizontal sync data, and auxiliary data are transmitted. On channel 1, pixel data for G data, two types of control data (CTL0, CTL1), and auxiliary data are transmitted. On channel 2, pixel data for R data, two types of control data (CTL2, CTL3), and auxiliary data are transmitted.

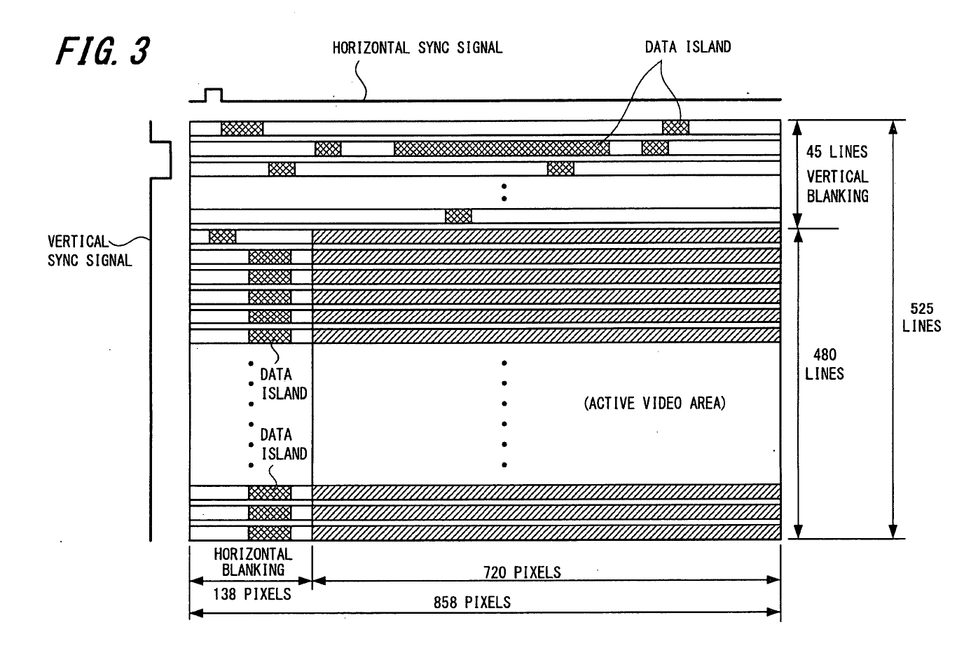

FIG. 3 is a diagram showing the line construction and pixel construction of one frame in video data transmitted by the transmission construction according to the present embodiment. The video data (main video data) transmitted according to the present embodiment is uncompressed data (that is, video data in single pixel units), and has a vertical blanking interval and a horizontal blanking interval appended thereto. More specifically, in the example in FIG. 3, pixel data with 720 pixels on 480 lines is used as the video area to be displayed (an area indicated as the active video area), and 858 pixels and 525 lines are used as the number of pixels and number of lines that include the blanking intervals. The areas shown by cross-hatching in the blanking intervals (that is, the areas obliquely shaded both from top left and top right) are referred to as “data islands” and are intervals where auxiliary data can be appended. Even when the number of pixels in one frame is further increased, substantially the same construction is used but with an increased number of pixels. However, if the number of pixels increases while the frame rate is kept the same, it will be necessary to make a corresponding increase in the speed of the pixel clock.

Next, the procedure of the transmission processing carried out with the above construction will be described. When the wireless reception apparatus 30 is connected to the sink device 40, the E-EDID information stored in the storage unit 44 of the sink device 40 is read out and is stored in the storage unit 25 of the wireless transmission apparatus 20.

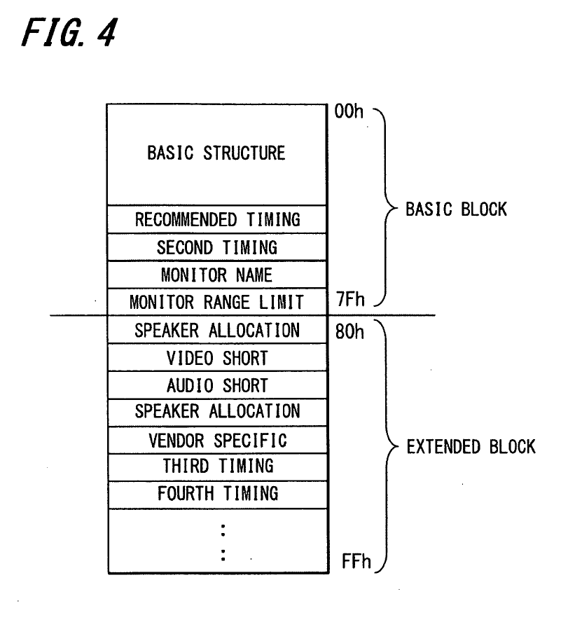

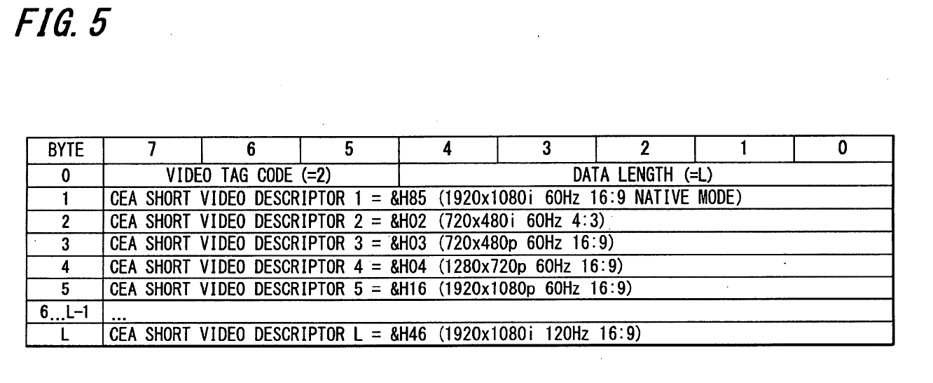

FIG. 4 is a diagram showing the data structure of the E-EDID information stored in the sink device 40. In the data structure shown in FIG. 4, details about the video signals that can be displayed by the sink device 40 are written in a “Video Short” region. FIG. 5 shows one example of video data stored in the “Video Short” region. Various values are defined, such as the number of pixels in one frame, the frame frequency, the aspect ratio of the video, and the like. That is, in the video signal formats defined according to a predetermined standard in a region from Byte#1 to Byte#L, formats that can be displayed by the sink device 40 are written as combinations of a resolution, a frame rate, and an aspect ratio.

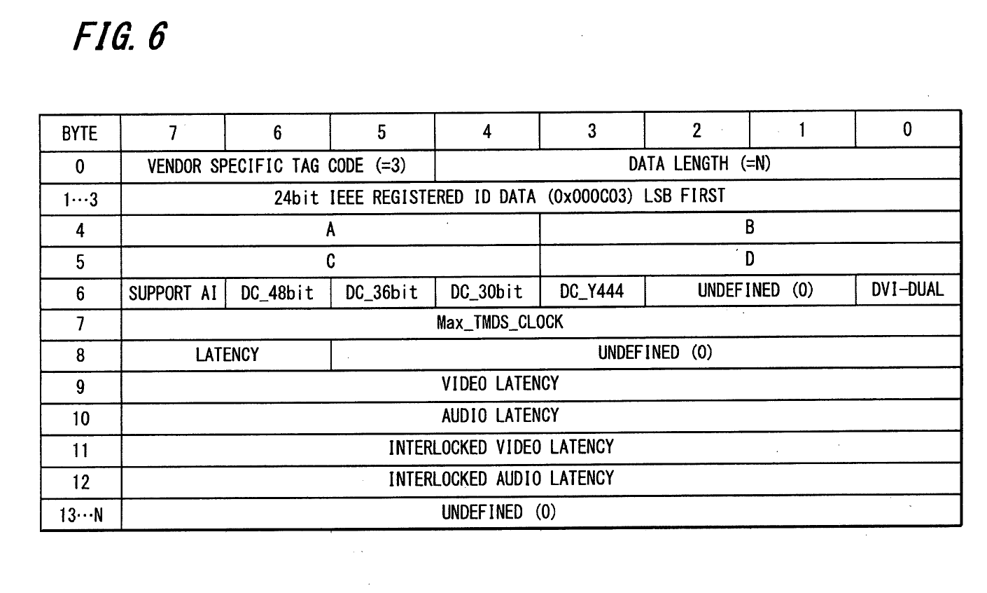

Also, as shown with Byte#6 in FIG. 6, signal format information (“Deep Color” information) showing signals that can be displayed by the sink device 40 is written in a “Vendor Specific” region in the E-EDID data structure diagram in FIG. 4. When an HDMI video signal is transmitted, video can be transmitted as an RGB signal or as a YCbCr signal, and 8 bit, 10 bit, 12 bit, 16 bit can be designated for the respective components.

For example, by setting Bit6, Bit5, and Bit4 of Byte#6 at “1” in the “Vendor Specific” data structure in FIG. 6, a display capability for 16 bit, 12 bit, and 10 bit data, respectively, is indicated.

Since it is possible to calculate the transmission rate required for transmission by reading such information, after video signal format information and signal format information (Deep Color information) that exceed the wireless transmission speed have been temporarily stored in the storage unit 25 of the wireless transmission apparatus 20, such information is deleted and processing that modifies the data in accordance with the state of the wireless transmission path is carried out.

When the source device 10 is connected to the wireless transmission apparatus 20 and there is a request to read the E-EDID information of the sink device 40, instead of reading from the sink device 40, the rewritten E-EDID information stored in the storage unit 25 of the wireless transmission apparatus 20 is transmitted to the source device 10. By doing so, it becomes possible to transmit the video data and the audio data within the transmission bandwidth rate achieved by the wireless connection.

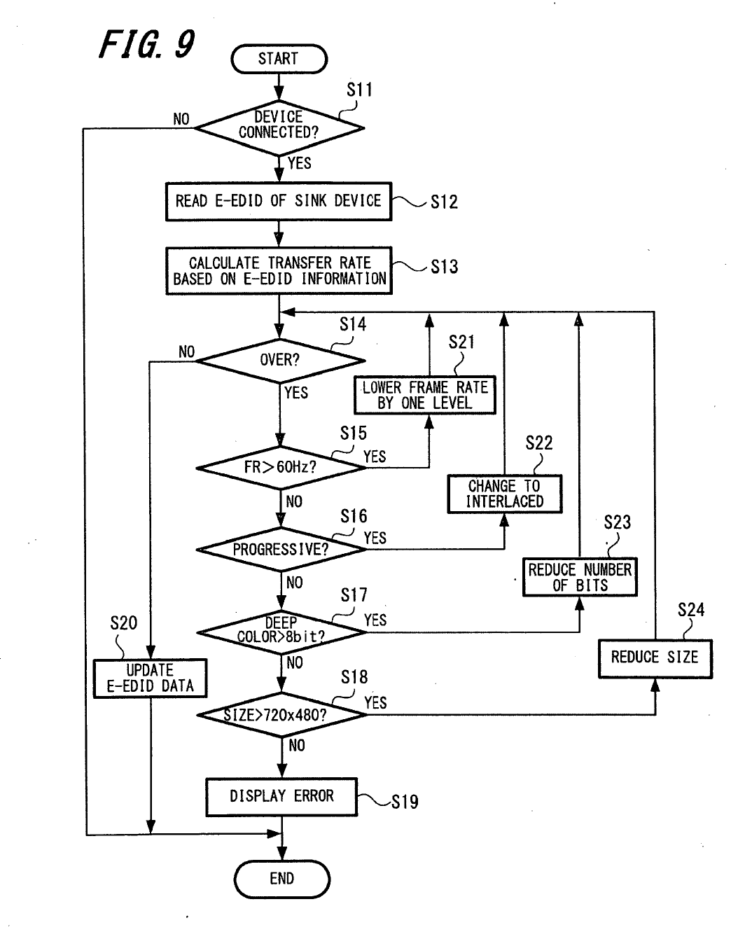

The flowchart in FIG. 9 shows the procedure of processing by the wireless transmission apparatus 20.

The wireless transmission apparatus 20 determines whether there is a connected sink device (step S11). If such determination finds that there is no connected sink device, the present processing ends.

If there is a connected sink device, the E-EDID information stored in the storage unit 44 of the sink device 40 is read out (step S12). Next, based on the read E-EDID information, the transmission rate is calculated (step S13). The maximum transmission rate found by such calculation is compared with a transmission rate at which transmission between the wireless transmission apparatus 20 and the wireless reception apparatus 30 is possible (step S14). When this comparison finds that the maximum transmission rate is lower than the wireless transmission rate, real-time transmission will be possible within the wireless transmission rate, and therefore the present processing is not carried out and the read E-EDID information is stored directly in the storage unit 25 of the wireless transmission apparatus 20 (step S20).

When the maximum transmission rate is higher than the wireless transmission rate, the E-EDID information is rewritten and processing is carried out so that the maximum transmission rate is equal to or lower than the wireless transmission rate.

As the processing, first, it is determined whether the frame rate is higher than 60 Hz (step S15). When this determination finds that the frame rate is 60 Hz or below, the processing next proceeds to the determination processing in step S16. When the frame rate is 60 Hz, the frame rate is halved and the maximum transmission rate is halved (step S21).

The transmission rate comparing processing in step S21 is then repeated using this maximum transmission rate information.

When the maximum transmission rate is still higher after the frame rate has been changed, it is then determined whether progressive output is carried out (step S16). Here, if interlaced output is carried out, the processing proceeds to the next determination (step S17). If the progressive output is carried out, the data is changed for interlaced output (step S22) to halve the maximum transmission rate.

The transmission rate comparing processing is then repeated using this maximum transmission rate information (step S14).

When the maximum transmission rate is still higher after a change to interlaced output, it is then determined whether the number of bits for each pixel is eight bits or above.

When the number of bits for each pixel is eight bits, the processing proceeds to the next determination processing (step S18).

When the number of bits for each pixel is eight bits or above, the number of bits in the data is lowered in order to 16, 12, 10, and then 8 bits (step S23) to reduce the maximum transmission rate.

The transmission rate comparing processing is then repeated using this maximum transmission rate information (step S14).

When the maximum transmission rate is still higher after the number of bits has been changed, it is then determined whether the resolution is D1 (720 by 480) or above (step S18). When the resolution is D1, a display indicating that it is not possible to transmit an HDMI signal by wireless transmission is displayed and the present processing ends (step S19). When the resolution is D1 or above, the resolution is lowered in the order 1920×1080, 1280×720, 720×480 (step S24) to lower the maximum transmission rate. The transmission rate comparing processing started from the step S14 is then repeated using this maximum transmission rate information.

When the maximum transmission rate is equal to or below the wireless transmission rate at any stage in the data processing described above, the video format information at such time is written in the storage unit 25 of the wireless transmission apparatus 20 (step S20), and the present processing ends.

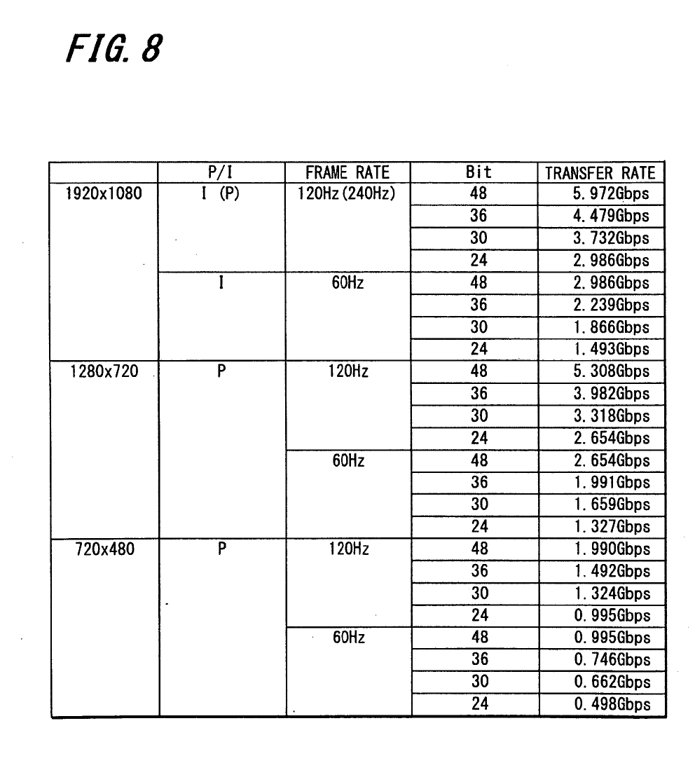

Note that although a procedure where the data is changed and it is successively determined whether the maximum transmission rate is within the wireless transmission rate has been described in the flowchart in FIG. 9, it is also possible to simplify the procedure of the processing by providing combinations of such parameters and calculation results in advance as a table, such as that shown in FIG. 8, for example, in the storage unit 25 of the wireless transmission apparatus 20 and comparing such information with the wireless transmission rate.

As described above, by carrying out the transmission processing according to the present embodiment, for a construction where data transmission is carried out according to HDMI standard between the source device and the sink device, it is possible to carry out wireless transmission having set a suitable transmission rate.

Note that although the above embodiment is described based on an HDMI standard interface, it is also possible to apply the present invention to other transmission standards. Regarding the source side device and the sink side device connected by the HDMI standard cable, it is also possible to use a construction where other video devices than the recording/reproducing apparatus and the television set shown in FIG. 1 are connected.

Also, although the wireless transmission apparatus 20 and the wireless reception apparatus 30 are connected between the source device 10 and the sink device 40 and only the connection between the wireless transmission apparatus 20 and the wireless reception apparatus 30 is wireless in the construction shown in FIG. 1 and described above in the present embodiment, the wireless transmission apparatus 20 may be incorporated in the source device 10 and the wireless reception apparatus 30 may be incorporated in the sink device 40.

Also, although only modification of the E-EDID information is carried out based on the wireless transmission state in the present embodiment described above, it is also possible to incorporate compression processing for transmission data at the wireless transmission apparatus 20 and decompression processing for reception data at the wireless reception apparatus 30.

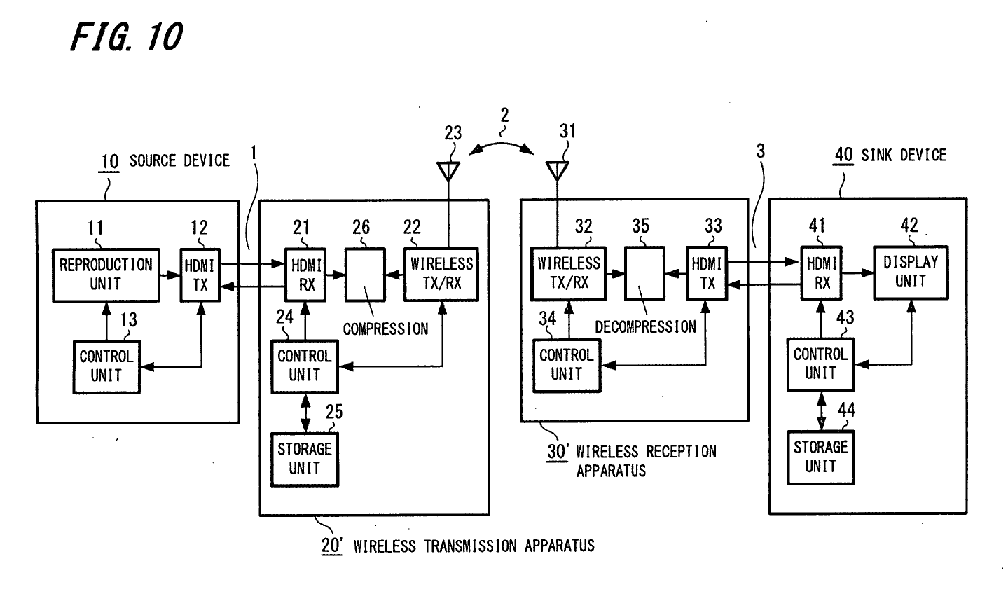

That is, as shown in FIG. 10 for example, a compression unit 26 that compresses and encodes data received by the HDMI reception unit 21 is provided with a wireless transmission apparatus 20′ and the data compressed by the compression unit 26 is wirelessly transmitted from the wireless transmission unit 22. The compression ratio at the compression unit 26 is set in accordance with the wireless transmission state. A decompression unit 35 that decompresses data received by the wireless reception unit 32 is provided with a wireless reception apparatus 30′ and the data decompressed by the decompression unit 35 is transmitted from the HDMI transmission unit 33. The decompression ratio at the decompression unit 35 is set in accordance with the compression ratio at the compression unit 26.

In addition to using such construction, a combination of processing that varies the compression ratio at the compression unit 26 and modification of the E-EDID information is carried out in accordance with the transmission state on the wireless transmission path. By combining modification of the E-EDID information and the processing that varies the compression ratio, greater sensitivity to the transmission state is possible.

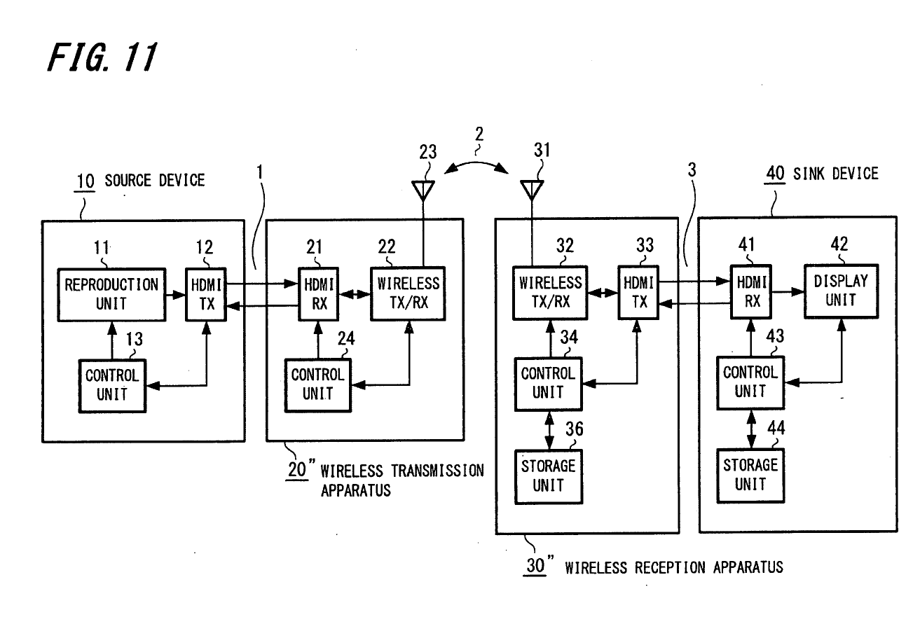

Also, although a construction where a storage unit that stores the E-EDID information is provided in the sink device is used in the present embodiment described above, as shown in FIG. 11 for example, it is also possible to provide a storage unit 36 in a wireless reception apparatus 30″ side and store the E-EDID information of the sink device in the storage unit 36. The E-EDID information stored in the storage unit 36 is read by the control unit 34 of the wireless reception apparatus 30 and is transmitted to the wireless transmission apparatus 20 side. The storage unit may be omitted from a sink device 40″.

In addition, although the wireless transmission standard IEEE 802.11n is applied in the present embodiment described above, it is also possible to apply various other wireless transmission standards. However, it is necessary to use a standard capable of transmitting data at a comparatively high speed.

### REFERENCE NUMERALS

1 . . . HDMI cable, 2 . . . wireless transmission path, 3 . . . HDMI cable, 10 . . . source device, 11 . . . reproduction unit, 12 . . . HDMI transmission unit, 12a, 12b, 12c . . . transmission processing unit, 13 . . . control unit, 20 . . . wireless transmission apparatus, 21 . . . HDMI reception unit, 21a, 21b, 21c . . . transmission processing units, 22 . . . wireless transmission/reception unit, 23 . . . antenna, 24 . . . control unit, 25 . . . storage unit, 26 . . . compression unit, 30 . . . wireless reception apparatus, 31 . . . antenna, 32 . . . wireless transmission/reception unit, 33 . . . HDMI transmission unit, 34 . . . control unit, 35 . . . decompression unit, 36 . . . storage unit, 40 . . . sink device, 41 . . . HDMI reception unit, 42 . . . display unit, 43 . . . control unit, 44 . . . storage unit

1. A transmission method of transmitting video data using a transmission technique where video data of predetermined bit units is transmitted in pixel data units from is source side apparatus to a sink side apparatus in synchronization with a pixel clock, characterized by comprising:
converting at least part of a transmission path between the source side apparatus and the sink side apparatus to a wireless transmission path;
storing, by the sink side apparatus, information relating to one of a display capability and a reproduction capability for video of the sink side apparatus;
determining one of a transmission speed and a transmission rate of video data on the wireless transmission path; and
modifying, by the source, side apparatus, when the source side apparatus reads out the information stored in the sink side apparatus relating to the one of the display capability and the reproduction capability for the video, the stored information in accordance with the one of the transmission speed and the transmission rate determined and transmitting the modified information to the source side apparatus.

2. A transmission system in which video data of predetermined bit units is transmitted in pixel data units from a source side apparatus to a sink side apparatus in synchronization with a pixel clock, characterized in that:
at least part of a transmission path between the source side apparatus and the sink side apparatus is converted, to a wireless transmission path;
the sink side apparatus includes a sink side storage unit that stores information relating to one of a display capability and a reproduction capability for video of the sink side apparatus;
at least one of the source side apparatus and the sink side apparatus includes a determining unit that determines one of a transmission speed and a transmission rate of video data on the wireless transmission path; and
the source side apparatus includes a modifying unit that modifies, when the one of the display capability and the reproduction capability for video stored in the sink side storage unit is read out, the stored information in accordance with the one of the transmission speed and the transmission rate determined by the determining unit.

3. The transmission system according to claim 2, characterized in that:
when the stored information is modified in accordance with the one of the transmission speed and the transmission rate determined by the determining unit, the information is modified to information with a lower transmission rate with priority starting from information where deterioration in one of display quality and reproduction quality is not conspicuous.

4. The transmission system according to claim 2, characterized in that:
the source side apparatus includes a compression unit that compresses video data to be transmitted in accordance with the one of the transmission speed and the transmission rate determined by the determining unit, and
the sink side apparatus includes a decompression unit that decompresses the transmitted video data.

5. A transmission apparatus that transmits video data of predetermined bit units in synchronization with a pixel clock to a sink side apparatus in pixel data units using a transmission path at least part of which is a wireless transmission path, the transmission apparatus characterized by comprising:
a determining unit that determines one of a transmission speed and a transmission rate of video data on the wireless transmission path;
a read unit that reads information on one of a display capability and a reproduction capability for video stored in a sink side storage unit; and
a modifying unit that modifies the information on capability read by the read unit in accordance with the one of the transmission speed and the transmission rate determined by the determining unit.

6. A transmission apparatus that transmits video data of predetermined bit units in synchronization with a pixel clock to a sink side apparatus in pixel data units using a transmission path at least part of which is a wireless transmission path, the transmission apparatus characterized by comprising:
a determining unit that determines one of a transmission speed and a transmission rate of vide of data on the wireless transmission path;
a read unit that reads information on one of a display capability and a reproduction capability for video stored in at sink side storage unit;
a modifying unit that modifies the information on capability read by the read unit in accordance with the one of the transmission speed and the transmission rate determined by the determining unit; and
a compression unit that compresses the video data to be transmitted in accordance with the information on capability read by the read unit.

7. A reception apparatus that receives video data of predetermined bit units in synchronization with a pixel clock from a source side apparatus in pixel data units using a transmission path at least part of which is a wireless transmission path, the reception apparatus characterized by comprising:
a storage unit that stores information relating to one of display capability and a reproduction capability for video of the reception apparatus; and
a decompression unit that decompresses the received video data based on a capability indicated by the information stored in the storage unit and one of a transmission speed and a transmission rate of video data on the wireless transmission path.
